(19) United States
(12) Patent Application Publication
(10) Pub. No.: US 2018/0096194 A1
(43) Pub. Date: Apr. 5, 2018

(54) Center-Surround Image Fusion

(71) Applicant: Her Majesty the Queen in Right of Canada as Represented by the Minister of Defence, Ottawa (CA)

(72) Inventor: Mackenzie G. Glaholt, Ottawa (CA)

(21) Appl. No.: 15/206,806

(22) Filed: Jul. 11, 2016

(51) Int. Cl. G06K 9/00; H04N 5/33; G02B 27/01

(52) U.S. Cl. CPC G06K 9/00228; G01J 2003/2826; G02B 27/017; H04N 5/332

(57) ABSTRACT

Described herein is a method for combining image information from different sensors in a center-surround scheme, whereby information from one or more sensors that are optimized for discrimination and identification is presented to the viewer's central vision and information from another sensor that is optimized for detection is presented to non-central vision (so-called ‘surround’)). More specifically, the sensor-fusion scheme presents long wave infra-red band (LWIR) imagery of the non-central visual field of the observed scene to the viewer's non-central vision and SWIR, VIS, and/or IINIR imagery of the central field of the observe scene to the viewer's central vision. This center-surround fusion scheme is optimized for the detection and identification of human targets.

### BACKGROUND OF THE INVENTION

There is an increasingly large array of electro-optic sensors available, including sensor imaging systems that capture light in the long-wave infrared band (e.g. 8-15 μm; henceforth LWIR), the short-wave infrared band (0.9-3 μm; henceforth SWIR), in addition to more traditional imaging technologies such as image intensification in near infrared (0.75-1.4 μm; henceforth IINIR), and visible spectrum imagery (400-700 nm; henceforth VIS). Each of these electro-optic sensors captures slightly different information about the visual scene and the objects in that scene. The problem faced by engineers is how to unify this complementary information and present a single image to the viewer that contains all or most of the useful information from the different sensor bands. This is the problem of image fusion (also known as sensor fusion; a subset of information fusion). One challenge with traditional image fusion techniques is that information in the form of imagery from each sensor competes for the same area in the fused image. For example, the SWIR image of a target object will contain certain information and the LWIR image of the same target object will contain somewhat different information. When the visual information from SWIR and LWIR images are directly combined to produce a fused image, then the two kinds of information compete for the same visual space and this can reduce or destroy the perceptual visibility of the information from one or both of the sensors.

Present image fusion techniques involve a variety of algorithms that combine information across the entire image. For example, for a fusion method that combines images from sensor 1 (s1) and sensor 2 (s2), the output image (f12) is a combination of s1 and s2. Imagery from s1 and s2 is fused across the whole image area to create f12; that is, each area of f12 contains information from s1 and s2.

As was discussed previously, a potential weakness of fusing imagery across the whole image is that the information from the two sensors competes for the same visual space in the fused image. This can result in ‘destructive interference’ where the information contained in one sensor obscures or obliterates the information from the other, resulting in a loss of information in the fused image.

U.S. Pat. No. 7,787,012 teaches a system and method for lining video images with an underlying visual field is described. Specifically, the image from for example a gun sight is super imposed over the image from for example a head mounted camera of the entire scene so as to facilitate targeting.

U.S. Pat. No. 7,620,265 teaches a method for performing composite color image fusions of thermal infrared and visible images.

U.S. Pat. No. 6,909,539 teaches a single sensor that can operate multiple bands and display either one radiation band alone or multiple overlay bands using an appropriate colour choice to distinguish the bands.

### SUMMARY OF THE INVENTION

According to an aspect of the invention, there is provided a method for displaying a center-surround image fusion of a scene comprising: providing a display having a central display region (“center”) whose imagery depicts the central visual field of the observed scene and is presented to the viewer's central vision; and a non-central display region (“surround”) whose imagery captures the non-central visual field of the observed scene and is presented to the viewer's non-central vision; receiving imaging data of a scene from a long-wave infrared band (LWIR) sensor to support target detection; receiving imaging data of the scene from at least one identification sensor selected from the group consisting of a short-wave infrared band (SWIR) sensor; an image intensification in near infrared band (IINIR) sensor, a visible spectrum band (VIS) sensor; and combinations thereof; displaying the imaging data of the scene from the LWIR sensor on the surround viewing region of the display; and displaying the imaging data of the scene from the at least one identification sensor on the center viewing region of the display. In general, the present invention specifies that sensor imagery that is optimized for target detection should be presented to the viewer's non-central vision while sensor imagery that is optimized for target discrimination and identification should be presented to the viewer's central vision.

According to a further aspect of the invention, there is provided a method for displaying two fused images (where each fused image is derived from two or more fused sensors) in a center-surround fashion comprising: providing a display having a central display region (“center”) whose imagery depicts the central visual field of the observed scene and is presented to the viewer's central vision; and a non-central display region (“surround”) whose imagery depicts the non-central visual field of the observed scene and is presented to the viewer's non-central vision; receiving imaging data of a scene from a long-wave infrared band (LWIR) sensor; receiving imaging data of the scene from at least one identification sensor selected from the group consisting of a short-wave infrared band (SWIR) sensor; an image intensification in near infrared band (IINIR) sensor, a visible spectrum band (VIS) sensor; and fused combinations thereof where image fusion produces an image that is biased towards one or the other component sensor; displaying the imaging data of the scene from the LWIR sensor and the at least one identification sensor on the surround viewing region of the display; and displaying the imaging data of the scene from the LWIR sensor and the at least one identification sensor on the center viewing region of the display, wherein the display is biased in favor of the LWIR sensor over the at least one identification sensor in the surround display region and biased in favor of the identification sensor(s) over the LWIR sensor in the center display region.

According to another aspect of the invention, there is provided a method for displaying a center-surround image fusion comprising: providing a display having a central (“center”) viewing region and a non-central (“surround”) viewing region; receiving imaging data of a scene from a long-wave infrared (LWIR) band sensor; receiving imaging data of the scene from at least one identification sensor selected from the group consisting of a short-wave infrared (SWIR) sensor; an image intensification in near infrared (IINIR) sensor, a visible spectrum (VIS) sensor; and combinations thereof; displaying the imaging data of the scene from the LWIR sensor on the surround viewing region of the display; and displaying the imaging data of the scene from the at least one identification sensor on the center viewing region of the display.

According to a further aspect of the invention, there is provided a method for displaying a center-surround image fusion comprising: providing a display having a center viewing region and a surround viewing region; receiving imaging data of a scene from a long-wave infrared (LWIR) band sensor; receiving imaging data of the scene from at least one identification sensor selected from the group consisting of a short-wave infrared (SWIR) sensor; an image intensification in near infrared (IINIR) sensor, a visible spectrum (VIS) sensor; and combinations thereof; displaying the fused imaging data of the scene from the LWIR sensor and the at least one identification sensor on the periphery viewing region of the display; and displaying the fused imaging data of the scene from the LWIR sensor and the at least one identification sensor on the center viewing region of the display, wherein the fused image is biased or weighted in favor of the LWIR sensor over the at least one identification sensor in the surround viewing region and biased or weighted in favor of the at least one identification sensor over the LWIR sensor in the center viewing area.

### BRIEF DESCRIPTION OF THE DRAWINGS

FIG. 1 shows one embodiment of the invention, a center-surround fusion scheme with a virtual circular aperture simulating the task of viewing a scene through an observation scope with SWIR and LWIR sensor imagers. In the gaze-contingent embodiment, the LWIR and SWIR images (aligned so as to depict the same field-of-view of the world) are masked based on the viewer's gaze position on the display: the display is updated such that the viewing aperture is continuously centered at the user's point of gaze, thereby ensuring that the center area (presenting SWIR imagery and masking LWIR) would be cast upon the viewer's central visual field and the surround area (presenting LWIR imagery and masking SWIR) would be cast upon the viewer's non-central visual field.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Described herein is a method for combining, in a center-surround scheme, image information from different sensors that image the same distal scene, whereby information from one sensor is presented to the viewer's central visual field and information from another sensor is presented to non-central visual field. In the most straight-forward implementation, both sensor imaging devices would sample the same area of the visual field in the outside world (e.g., 30°) and the center-surround fusion would occur at the point of the display, where the imagery from the central field of view of one sensor (e.g., central 8°) would be presented to the viewer's central visual field, and the non-central field of view (e.g., from eccentricity 4° to 15°) of the other sensor would be presented to the viewer's non-central field of view. In general, the present invention specifies that imagery from imaging sensors that facilitate target detection should be presented to the viewer's non-central vision while imagery from imaging sensors that facilitate target discrimination and identification should be presented to the viewer's central vision. More specifically, the center-surround fusion scheme presents LWIR imagery from the non-central field of view to the viewer's non-central visual field and presents SWIR, VIS, and/or IINIR imagery from the central field of view to the viewer's central visual field. These combinations allow for optimized human target detection and identification within the observed scene.

To the inventor's knowledge, the characteristics of non-central human vision have not been discussed when designing fused imagery displays. Instead, the characteristics of central vision are considered (e.g. maximum sensitivity to spatial frequencies), but it is believed that no one has investigated the role of visual saliency in the human non-central visual field as a function of sensor. Specifically, the instant invention exploits the central-peripheral distinction in human vision, which has not previously been considered in the context of image fusion.

As discussed herein, these center-surround fusion schemes are optimized based on the characteristics of the human visual system. In particular, the idea is motivated from the arrangement of the retinal photoreceptors: the visual field is typically divided into the fovea (central 3° about the point of eye fixation), parafovea (central 9° excluding the fovea), and perifovea (central 18°, excluding fovea and parafovea), and the remaining area outside of the perifovea is referred to as the periphery. The area of the retina receiving the central visual field (known as the macula) including the fovea, parafovea, and perifoveal, has high concentrations of cone photoreceptors and is sensitive to high spatial frequencies (i.e., high acuity) and chromatic information. However, the density of retinal photoreceptors drops off steeply outside of the fovea, and it is the fovea this is used primarily for the extraction of fine detail from the visual field. The perifoveal and peripheral visual fields have low acuity but are nevertheless sensitive to stimuli with high luminance contrast, as well as luminance transients and motion. These anatomical characteristics are important from the perspective of sensor fusion, because sensors differ in terms of the kind of information as well as the level of detail they provide. More specifically, SWIR, IINIR, and VIS imagery each present high detail information that will be optimally processed in central vision. LWIR imagery tends to contain information that is less detailed, but more importantly it has the benefit of sensing light emitted by warm, heat-emitting or heat-generating objects or targets, such as but by no means limited to humans, animals, and running vehicles, which tend to produce a LWIR signature that has high luminance contrast. For this reason, LWIR imagery is ideal for detection of these targets, but poor for target identification. Conversely, SWIR, IINIR, and VIS, imagery are strong for identification but weaker (than LWIR) for detection. Thus, the optimal presentation of these sensors to the viewer involves presenting LWIR imagery of the non-central visual field in the observed scene to the viewer's non-central vision and SWIR, IINIR, and/or VIS imagery of the central visual field of the observed scene to the viewer's central vision.

According to an aspect of the invention, there is provided a method for displaying a center-surround image fusion comprising: providing a display having a central display region (“center”) whose imagery depicts the central visual field of the observed scene and is presented to the viewer's central vision; and a non-central display region (“surround”) whose imagery captures the non-central visual field of the observed scene and is presented to the viewer's non-central vision; receiving imaging data of a scene from a long-wave infrared band (LWIR) sensor to support target detection; receiving imaging data of the scene from at least one identification sensor selected from the group consisting of a short-wave infrared band (SWIR) sensor; an image intensification in near infrared band (IINIR) sensor, a visible spectrum band (VIS) sensor; and combinations thereof; displaying the imaging data of the scene from the LWIR sensor on the surround viewing region of the display; and displaying the imaging data of the scene from the at least one identification sensor on the center viewing region of the display. In general, the present invention specifies that sensor imagery that is optimized for target detection should be presented to the viewer's non-central vision while sensor imagery that is optimized for target discrimination and identification should be presented to the viewer's central vision.

According to a further aspect of the invention, there is provided a method for displaying two fused images (where each fused image is derived from two or more fused sensors) in a center-surround fashion comprising: providing a display having a central display region (“center”) whose imagery depicts the central visual field of the observed scene and is presented to the viewer's central vision; and a non-central display region (“surround”) whose imagery depicts the non-central visual field of the observed scene and is presented to the viewer's non-central vision); receiving imaging data of a scene from a long-wave infrared band (LWIR) sensor; receiving imaging data of the scene from at least one identification sensor selected from the group consisting of a short-wave infrared band (SWIR) sensor; an image intensification in near infrared band (IINIR) sensor, a visible spectrum band (VIS) sensor; and fused combinations thereof where image fusion produces an image that is biased towards one or the other component sensor; displaying the imaging data of the scene from the LWIR sensor and the identification sensor on the surround viewing region of the display; and displaying the imaging data of the scene from the LWIR sensor and the at least one identification sensor on the center viewing region of the display, wherein the display is biased in favor of the LWIR sensor over the at least one identification sensor in the surround display region and biased in favor of the identification sensor over the LWIR sensor in the center display region. As will be appreciated by one of skill in the art, this is in contrast with the prior art that teaches image fusion over the entire image and/or teaches equal contribution from all sensors across the entire fused image.

As will be apparent to one of skill in the art, the size of the center region is a design choice and can be varied according to user preference and/or the intended use of the display. Specifically, the center region has to be large enough to cover the targets that are being search for and identified by the viewer. For example, in some embodiments, center-surround fusion is applied to assist in the search for human targets. For the detection of human targets, the angular size of the target depends on the distance from the viewer. Presuming a standing target of average height (1.75 m) and a 1× magnification sensor/display system, the angular sizes are as follows (see Table 1):

TABLE 1
Angular size of a 1.75 m tall human target as a function
of distance from viewer assuming a 1x magnification.

| | Vertical visual angle occupied by a |
|---|---|
| Target distance from viewer (m) | human target (°) |
| 25 | 4.00 |
| 50 | 2.00 |
| 100 | 1.00 |
| 200 | 0.50 |

Thus even at a relatively close viewing distance of 25 m, a circular 5° window is suitable to encompass a human target. The reason that it is important that the target be encompassed by the center region is that if the target has a larger angular size than the center region, it will be depicted partly in the center sensor imagery and partly in the surround sensor imagery, which might interfere with identification performance. As will be apparent to one of skill in the art, these angular target sizes assume a 1:1 representation of real-life visual angle to displayed size (e.g. a 1× magnification system). The apparent target size also depends on the viewer's distance from the screen on which the display is projected (e.g. a computer screen, head-mounted display, or an observation scope). For example, based on these values, for a 1× magnification observation periscope with a field of view of 15°, designed for detecting targets at distances of 25 m or greater, a suitable center-surround fusion scheme would have the central 5° (circular with radius of 2.5°) in SWIR, VIS, or IINI, and the remaining surrounding area (from a radius of 2.5° to a radius 7.5°, for example) would be presented in LWIR. This center size might also be suitable for digital binoculars. Binoculars are typically used to observe targets further than ˜200 m, and even when searching for larger targets (e.g. vehicles, perhaps 10 m×10 m), when the user directed it to the target, these targets would still be encompassed by central field of view, corresponding to the center display area. Nevertheless, one might enlarge the central area to accommodate larger and/or nearer targets. For example, if a known target size is 10 m×10 m, and the target needed to be identified through the display at 100 m, the target would occupy a 5.72° square, and thus a larger center region would be needed to encompass the target (e.g., circular 8-10° diameter). Typically the ‘center’ region in the center-surround fusion scheme would have a minimum diameter of 3° of the viewer's visual angle (i.e., to cover the fovea), but depending on the application it could be as large as 30°, and the remaining area outside of that center region would be the ‘surround’ and would present LWIR imagery. Accordingly, in some embodiments, the diameter center region of the display could range from 1.5° to 30°, or from 1.5° to 25°, or from 1.5° to 20° or from 1.5° to 15° or from 1.5° to 10° or from 3° to 30° or from 3° to 25° or from 3° to 20° or from 3° to 15°. Furthermore, it is important to note that while “circular” and “diameter” are used in reference to the center region of the display, this is done for convenience and the shape of the center display is in no way limited to circular or generally circular shapes. It is of note that one of skill in the art can easily determine corresponding sizes for displays of different shapes.

In general, the optimal setting for the ‘center’ area would include the minimum area of the visual field required to support target discrimination and identification as well any other device-specific viewing tasks requiring imagery with high visual detail. This all assumes that the imaging device uses 1× magnification. If greater magnification is used, the size of the center area should scale such that it can cover the intended search target as it would appear at the minimum stand-off distance. This also requires that the viewer observe the imagery from the appropriate distance to ensure that the central area appears at the appropriate retinal size (e.g. an intended 5° diameter central display area actually occupies approximately the central 5° on the viewer's retina when looking straight ahead at the display). This will typically require a fixed viewing distance from the display.

Furthermore, as discussed herein, center-surround fusion produces a visible edge between the two sensors that would initially appear to be less desirable than uniform whole-field viewing which has likely dissuaded its development. In fact, in our testing, we have observed a small, but measurable, performance penalty due to the ‘mis-match’ in target/scene appearance between the center and surround imagery. However, despite this apparent problem, we have surprisingly found that the center-surround arrangement produces performance enhancements over control conditions that out-weigh the cost of the ‘mis-match’. Furthermore, this visual edge and associated performance cost might be mitigated by producing LWIR-biased fusion in the non-central region and SWIR-, VIS-, or IINI-biased fusion in the central region, as discussed herein.

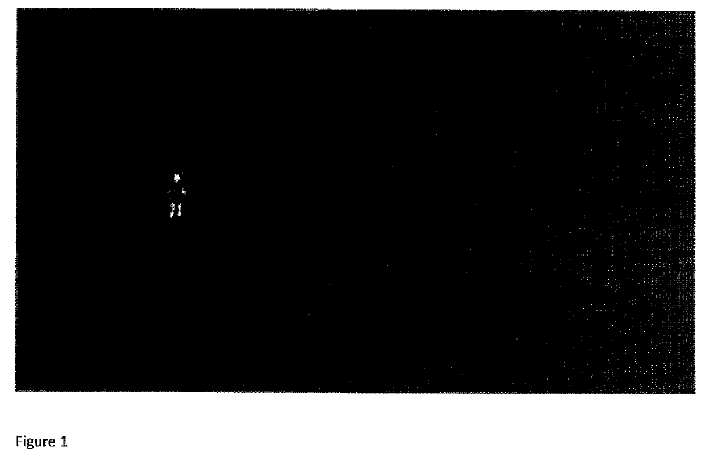

In some embodiments, there is provided a gaze-contingent display technique in which a viewer's eye movements are monitored while viewing imagery on a display (e.g. a computer screen). If the eye tracking has suitably high temporal precision and spatial accuracy, the display can be updated in real time such that the center display area continuously coincides with the viewer's central visual field and the surround imagery continuously coincides with the viewer's non-central visual field (see FIG. 1; display updated according to the viewer's gaze position). This produces the purest form of the center-surround fusion, where the “center” sensor is information is provided strictly to the viewer's central vision and the “surround” sensor information to non-central vision.

The center-surround fusion scheme could also be implemented in a head-mounted display (HMD), a night vision goggle system, or potentially for binoculars or an observation scope with a sufficiently large field of view (i.e. such that when viewing the center of the display, part of the display stimulates non-central vision). For a sufficiently wide field of view display (e.g. a night-vision goggle (NVG) system with a 120° horizontal field of view), the center region might be selected to be somewhat larger (e.g. 20°×20°, or 30°×30°, circular) in order to accommodate tasks that demand high resolution from a relatively wide area of central vision (e.g. maneuvering over obstacles). Note that for the NVG, HMD, binocular, or observation scope implementations, the display might not be gaze-contingent (due to the difficulty of incorporating eye-tracking into those devices), and hence the center and surround areas of the display might not be strictly coupled to the user's central and non-central visual fields. For these devices, the center and surround display areas would only map directly onto the viewer's central and non-central visual fields when the viewer was gazing straight ahead, and movement of the device (by head-movements or arm-movements) would be required to align the center display area with objects of interest in the visual field. In addition, the user would be free to make eye movements to the surround display area, and in those cases the surround display area would coincide with the user's central visual field. While this decoupling might be sub-optimal from a detection/identification point of view, data collected in our laboratory using mouse-contingent control over the position of a center-surround window (e.g. FIG. 1) suggested that even when eye movements and center-surround display areas are decoupled and the viewing aperture is controlled by an overt motor movement, on average the viewer tends to view the center area with central vision and the surround area with non-central vision, and consequently the center-surround fusion scheme still constituted an optimization for detection and identification in this context.

In general, the present invention specifies that sensor imagery that is optimized for target detection should be presented to non-central vision while sensor imagery that is optimized for target discrimination and identification should be presented to central vision. In particular, during daylight, the best sensor for discrimination and identification is likely to be the VIS or SWIR imagery. VIS imagery has the advantage over SWIR in producing a more familiar image and it also conveys colour information which can facilitate target discrimination. However, during night operations, the IINI and SWIR sensors will outperform the visible spectrum sensor which has very low contrast at night. Performance of the central sensor is also dependent on resolution, as sensors with higher resolution will promote better central target discrimination. Furthermore, in some embodiments, the central sensor benefits from a fused display between one or more component sensors (VIS, SWIR, IINI). In addition, while the LWIR sensor is likely to provide the best target detection performance in many cases (e.g. detecting human targets against a forest background), in other contexts, other sensor imagers might provide the best detection performance and thus should be presented in the surround display area. As will be apparent to one of skill in the art, in some embodiments of the invention, the display options may include different, pre-determined combinations of the sensors as well as combinations where the proportion of the different sensors is either pre-set or user-defined for use in particular conditions, for example, specific light and/or weather conditions and/or for certain uses.

Thus, rather than fusing sensors across the entire image, where each area of the fused image contains information from each sensor, in the instant invention, the information from the LWIR sensor is presented to a different area of the display (the non-central fields) than the information from the VIS, SWIR and/or IINI sensors (the central field), thus avoiding the interference issue. In general, the central sensor imagery is optimized for target discrimination and identification (VIS, SWIR, or IINI) and the imagery presented to the non-central visual field is optimized for target detection (LWIR), as discussed herein.

In another embodiment of the invention, the non-central regions of the display provide a fused image arranged to create a bias in LWIR in the area of the display presented to the non-central visual field, and a bias toward VIS, IINIR or SWIR is displayed in the central area of the display presented to the viewer's central visual field. More specifically, if sensor fusion is achieved through a weighted average between two sensors, the weighting for the non-central visual field is biased toward LWIR and the weighting for the central field is biased toward VIS, IINIR, and/or SWIR. As will be appreciated by one of skill in the art, in these embodiments, the apparent “edge” between sensors in the display could be minimized. Furthermore, the degree to which the different regions of the display are biased could be varied, either by the user or as a series of one or more pre-defined settings. For example, some settings could incorporate a greater percentage of VIS, IINIR and/or SWIR in the surround display area. Alternatively, the bias is graduated, that is, so that the transition from displaying VIS, IINIR and/or SWIR in the center region to LWIR in the peripheral region is smooth. For, example, in these embodiments, the percentage of VIS, IINIR and/or SWIR displayed is highest in the center region and then would diminish proportionally or relative to increasing distance away from the center region.

As will be apparent to one of skill in the art, center-surround image fusion can be applied to any viewing device that incorporates the appropriate sensor imaging and displays. In particular, it is useful for devices that are used to scan a visual scene for targets present in that scene. Suitable devices include but are by no means limited to binoculars incorporating electro-optic sensors and digital displays; head-mounted goggles (e.g. night vision goggles); observation scopes that incorporate electro-optic sensors and digital displays; and vehicle-based head-mounted or screen-based viewing of sensor imagery (e.g. displays in land vehicles, aircraft, or displays for sensor feeds on unmanned surveillance vehicles).

The invention will now be further described by way of examples; however, the invention is not necessarily limited to the examples.

### Examples

In order to demonstrate the performance advantage of center-surround fusion, we employed a gaze-contingent display in which eye movements are monitored and the screen is updated such that one sensor image is presented to the central 5° of vision and another sensor image is presented to the surrounding area. Under these conditions, we observed performance optimization for a center-surround scheme with SWIR at the center of the display and LWIR in the surrounding area of the display. In particular, this configuration demonstrated very similar detection performance to the LWIR single band (i.e., same sensor in center and surround) condition which was the superior sensor for detection, and identification performance very similar to the SWIR single band condition which was the superior sensor for identification. Note that the reverse center-surround scheme (LWIR in the central visual field, SWIR in non-central) produced inefficient detection and identification performance.

Gaze-contingent display is unlikely to be available in many of the application settings (e.g. binoculars, head-mounted displays) and hence we sought to determine whether or not the method would still provide advantages if the center-surround fusion display was not strictly yoked to the viewer's visual field (i.e., gaze contingent) but rather was fixed within a viewing aperture that is moved (e.g., panned) by the user. This method of display would be compatible, for example, with an observation scope with a digital weapon sight in which SWIR was presented in the center of the display (central 5°) and LWIR was presented outside of that center area (outside of central 5° and until the maximum field of view, e.g., 15°). To test this implementation of center-surround fusion, we conducted an experiment using a mouse-contingent viewing mode. In this mode, a scene was presented on the screen and the scene was viewed through a virtual circular aperture (see FIG. 1) that constituted a center-surround fusion scheme. The user moved the virtual aperture around the screen using a mouse and searched for, and identified, human targets in the scene

Under this mouse-contingent viewing mode, where the gaze position and center-surround fusion scheme are not strictly coupled, we still observed a performance advantage for center-surround fusion versus control conditions. This is because the user tends to view the center of the aperture, and thus the surround portion of the display tends to be presented to non-central vision. This indicates that center-surround fusion can be implemented in an observation scope, digital binoculars, or other viewing device where the scene is scanned by manually moving the device's field of view.

The scope of the claims should not be limited by the preferred embodiments set forth in the examples but should be given the broadest interpretation consistent with the description as a whole.

1. A method for displaying a center-surround image fusion comprising:
providing a display having a central (“center”) viewing region whose imagery depicts the central visual field of the observed scene and a non-central (“surround”) viewing region whose imagery depicts the non-central visual field of the observed scene;
receiving imaging data of a scene from a long-wave infrared (LWIR) band sensor;
receiving imaging data of the scene from at least one identification sensor selected from the group consisting of a short-wave infrared (SWIR) sensor; an image intensification in near infrared (IINIR) sensor, a visible spectrum (VIS) sensor; and combinations thereof;
displaying the imaging data of the scene from the LWIR sensor on the surround viewing region of the display; and
displaying the imaging data of the scene from the at least one identification sensor on the center viewing region of the display.

2. The method according to claim 1 wherein the center viewing region of the display is in a fixed position relative to the display.

3. The method according to claim 1 wherein the center viewing region of the display is determined by the user's gaze position within the display.

4. The method according to claim 1 wherein the center region has a radius of is 1.5°-15° of the display, depending on the specific use of the device.

5. The method according to claim 1 wherein the display is in a device selected from the group consisting of: digital binoculars; head-mounted goggles; digital scopes; and vehicle displays.

6. The method according to claim 1 wherein only the LWIR sensor imaging data is displayed on the surround region of the display.

7. A method for displaying a center-surround image fusion comprising:
providing a display having a center viewing region whose imagery depicts the central visual field of the observed scene and a surround viewing region whose imagery depicts the non-central visual field of the observed scene;
receiving imaging data of a scene from a long-wave infrared (LWIR) band sensor;
receiving imaging data of the scene from at least one identification sensor selected from the group consisting of a short-wave infrared (SWIR) sensor; an image intensification in near infrared (IINIR) sensor, a visible spectrum (VIS) sensor; and combinations thereof;
displaying the fused imaging data of the scene from the LWIR sensor and the at least one identification sensor on the surround viewing region of the display; and
displaying the fused imaging data of the scene from the LWIR sensor and the at least one identification sensor on the center viewing region of the display,
wherein the fused image is biased or weighted in favor of the LWIR sensor over the at least one identification sensor in the surround viewing region and biased or weighted in favor of the at least one identification sensor over the LWIR sensor in the center viewing region.

8. The method according to claim 7 wherein the center viewing region of the display is in a fixed position relative to the display.

9. The method according to claim 7 wherein the center viewing region of the display is determined by the user's gaze position within the display.

10. The method according to claim 7 wherein the radius of the center region is 1.5°-15° of the display.

11. The method according to claim 7 wherein the display is in a device selected from the group consisting of: digital binoculars; head-mounted goggles; digital scopes; and vehicle displays.
